(19) United States
(12) Patent Application Publication
(10) Pub. No.: US 2022/0390896 A1
(43) Pub. Date: Dec. 8, 2022

(54) TIMEPIECE OSCILLATOR ASSEMBLY DEVICE

(71) Applicant: ROLEX SA, Geneva (CH)

(72) Inventors: Jean-Louis Bertrand, Plan-les-Ouates (CH); Pierre Villaret, Villy-le-Pelloux (FR)

(73) Assignee: ROLEX SA, Geneva (CH)

(21) Appl. No.: 17/828,497

(22) Filed: May 31, 2022

(30) Foreign Application Priority Data
Jun. 3, 2021 (EP) 21177591.1

(51) Int. Cl. G04B 15/14

(52) U.S. Cl. CPC G04B 15/14

(57) ABSTRACT

A device (200) for assembling an oscillator (100) including a spiral spring (1) to an assembly (300) or to a movement (300) of a timepiece (400),

a first movement-blank (5) for pivoting the oscillator (100), a second pivot movement-blank (6) for pivoting the oscillator (100), a first element (7a, 7b) for positioning the first movement-blank (5) relative to the second movement-blank (6), the first positioning element (7a, 7b) being arranged and/or configured so as to position a spiral spring (1) relative to the first movement-blank (5) and/or relative to the second movement-blank (6) in a plane of the assembly (300) or of the movement (300).

This application claims priority of European patent application No. EP21177591.1 filed Jun. 3, 2021, the content of which is hereby incorporated by reference herein in its entirety.

### BACKGROUND ART

The invention concerns a timepiece oscillator assembly device. The invention also concerns an assembly, in particular a timepiece movement, including such a device. The invention also concerns a timepiece including such an assembly device or such an assembly or such a timepiece movement.

A balance-spiral spring oscillator is conventionally mounted in a timepiece movement by placement of a set of parts predisposed on a balance bridge that are designed to allow movement in rotation of the outer end of the spiral spring in order to easily put the movement into beat so that at the dead centre or equilibrium position of the oscillator the centre of a balance pin plate is on a line connecting the pivots of the escapement lever and of the balance. To this end, the outer end of the spiral spring is usually fixed to the balance bridge by means of a mobile fastening support, for example a balance-spring stud support, that is movable in rotation relative to the balance bridge or to the plate.

The document EP2799937 describes, for example, a solution for assembling a balance-spiral spring oscillator in which an outer end of a spiral spring is fixed to a balance bridge by means of a mobile fastening support mobile in rotation relative to the balance bridge. Here the mobile fastening support is fastened to a shock absorber body that can be actuated in rotation via a specific driving zone.

The document EP2565730 discloses an escapement carrier module designed to pivot the components of the regulating member, which is shaped to be mounted directly on the plate of the movement. All the components of the regulating member are arranged so that they can be assembled in an automated manner from only one side of the module. This device is free of any index assembly and of any device enabling mechanical adjustment of the position of the outer end of the spiral spring. The outer end of this spring is fastened to a lower bridge of the module by means of a balance-spring stud fixed to a receiving surface of the bridge, for example by driving, welding or gluing it.

The document EP2570868 describes an oscillator including a spiral spring the outer end of which can be fastened to a fixed part of the movement, for example the plate, the lever escapement bridge or the balance bridge. In the embodiment more specifically described, a balance-spring stud fastened to the outer end of the spiral spring is designed to be inserted in a bore in the plate and to be retained axially by a small plate screwed onto the plate.

Demounting the spiral springs known from the documents EP2565730 and EP2570868 may prove difficult and generate a risk of breakage, in particular if these spiral springs are made of a fragile material such as silicon. Moreover, such solutions for assembly of the outer end of a spiral spring have an accuracy of assembly of the balance-spiral spring oscillator in the movement that is not the optimum. Finally, the assembly of the spiral spring that is more particularly described in the document EP2570868 implies mounting the spiral spring under the balance, which does not make it possible to show and to render particularly visible the spiral spring within the balance-spiral spring oscillator.

### SUMMARY OF THE INVENTION

The object of the invention is to provide a device for assembling a timepiece oscillator enabling improvement of the timepiece oscillator assembly devices known in the prior art. In particular, the invention proposes an oscillator assembly device improving the integration of an oscillator in a movement, more particularly of a spiral spring of an oscillator in a movement, and this independently of any mobile fastening support movable in rotation relative to a balance bridge or to a plate in a plane of the movement.

A timepiece oscillator assembly device in accordance with a first aspect of the invention is defined by point 1 below.
1. A device for assembling an oscillator including a spiral spring to an assembly or to a movement of a timepiece, the assembly device including:
   a first movement-blank for pivoting the oscillator,
   a second movement-blank for pivoting the oscillator,
   a first element for positioning the first movement-blank relative to the second movement-blank, the first positioning element being arranged and/or configured so as to position a spiral spring relative to the first movement-blank and/or relative to the second movement-blank in a plane of the assembly or of the movement.

Embodiments of the assembly device are defined by points 2 to 12 below.
2. The assembly device as defined in the preceding point, characterised in that:
   the first positioning element is included in the second movement-blank and the first movement-blank includes a second positioning element intended to cooperate with the first positioning element, or
   the first positioning element is included in the first movement-blank and the second movement-blank includes a second positioning element intended to cooperate with the first positioning element.
3. The assembly device as defined in the preceding point, characterised in that the second positioning element) includes a first opening, in particular a first opening with a circular section, and/or a second opening, in particular a second opening with an oblong section.
4. The assembly device as defined in any one of the preceding points, characterised in that:
   the first movement-blank is a balance bridge, and/or
   the second movement-blank is a plate.
5. The assembly device as defined in any one of the preceding points, characterised in that it includes a third movement-blank, the third movement-blank being for example a protection bridge and/or the third movement-blank being for example inserted or disposed between the first and second movement-blanks.
6. The assembly device as defined in any one of the preceding points, characterised in that it includes a first fastening element and a second fastening element, the first fastening element cooperating with the second fastening element to fasten a spiral spring to the first movement-blank and/or to the second movement-blank.
7. The assembly device as defined in the preceding point, characterised in that the second fastening element and the first positioning element are merged.
8. The assembly device as defined in point 6 or 7, characterised in that the first fastening element includes at least one first thread and in that the second fastening element includes at least one second thread, fastening being achieved by screwing the first thread into the second thread to press the spiral spring onto the first movement-blank and/or onto the second movement-blank.
9. The assembly device as defined in any one of the preceding points, characterised in that the first positioning element includes a first means for positioning the spiral spring and/or a second means for positioning the first movement-blank and/or a third means for positioning the third movement-blank and/or a fourth means for positioning the second movement-blank.
10. The assembly device as defined in any one of the preceding points, characterised in that the first positioning element includes a first screw foot and/or a second screw foot.
11. The assembly device as defined in any one of the preceding points, characterised in that it includes a first axial clearance adjustment element and a second axial clearance adjustment element, the first axial clearance adjustment element cooperating with the second axial clearance adjustment element to adjust the axial clearance of an oscillator, the first axial clearance adjustment element including for example a nut and the second axial clearance adjustment element including for example a thread formed on a screw foot.
12. The assembly device as defined in any one of the preceding points, characterised in that the first movement-blank and the second movement-blank are arranged and/or configured to retain a spiral spring between them, in particular to retain a spiral spring and a third movement-blank between them.

An assembly in accordance with the first aspect of the invention is defined by point 13 below.
13. An assembly, in particular a timepiece movement, including an assembly device as defined in any one of the preceding points and an oscillator including a spiral spring, in particular an oscillator including a balance and a spiral spring mounted on a staff.

Embodiments of the assembly are defined by points 14 and 15 below.
14. The assembly as defined in the preceding point, characterised in that the spiral spring, in particular an outer and/or solid and/or rigid part of the spiral spring, includes a third positioning element intended to cooperate with the first positioning element.
15. The assembly as defined in the preceding point, characterised in that the third positioning element includes a third opening, in particular a third opening with a circular section, and/or a fourth opening, in particular a fourth opening with an oblong section.

A timepiece in accordance with the first aspect of the invention is defined by point 16 below.
16. A timepiece, in particular a wristwatch, including an assembly device as defined in any one of points 1 to 12 and/or an assembly as defined in any one of points 13 to 15.

The appended drawings represent, by way of example, one embodiment of a timepiece.

### BRIEF DESCRIPTION OF THE DRAWINGS

FIG. 1 is a view of one embodiment of a timepiece.

FIG. 2 is a view of the FIG. 1 embodiment in which the balance bridge has been removed.

FIG. 3 is a view of the embodiment in section on the section plane III-III in FIG. 1.

FIG. 4 is a partial detail view of the embodiment in section on the section plane III-III in FIG. 1.

### DETAILED DESCRIPTION OF PARTICULAR EMBODIMENTS

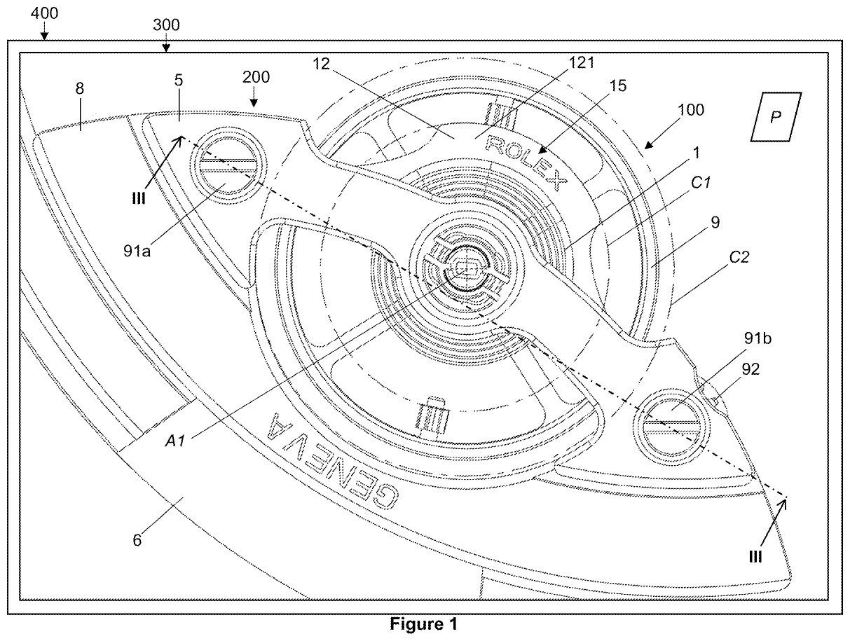

One embodiment of a timepiece 400 is described in detail hereinafter with reference to FIGS. 1 to 4.

The timepiece 400 is for example a watch, in particular a wristwatch. The timepiece 400 includes an assembly 300, in particular a timepiece movement 300, intended to be mounted in a timepiece case in order to protect it from the external environment. The timepiece movement 300 may be a mechanical movement, in particular an automatic movement, or a hybrid movement.

The assembly 300, in particular the timepiece movement 300, includes an assembly device 200 and an oscillator 100 including a spiral spring 1, in particular an oscillator 100 including a balance 9 and a spiral spring 1 mounted on a staff or a shaft 10. The staff 10 is advantageously a pivot staff of the oscillator, in particular of the balance 9. The oscillator can therefore be pivoted about a geometric axis A1.

The oscillator 100 assembly device 200 enables assembly of the oscillator on or in the assembly 300 or on or in the movement 300, that is to say enables it to be retained and/or guided, in particular guided in pivoting.

The assembly device 200 includes:
a first movement-blank 5 for pivoting the oscillator 100,
a second movement-blank 6 for pivoting the oscillator 100, and
a first element 7a, 7b for positioning the first movement-blank 5 relative to the second movement-blank 6.

The first positioning element 7a, 7b is arranged and/or configured so as to position the spiral spring 1 relative to the first movement-blank 5 and/or relative to the second movement-blank 6 in a plane P of the assembly 300 or of the movement 300.

The plane P is advantageously a plane in which the movement lies, in particular a plane parallel to the plane in which the movement-blanks of the movement, in particular the first and second movement-blanks 5 and 6, lie or parallel to the disks of the wheels of a finishing wheel set of the movement or perpendicular to the axes of the wheels of a finishing wheel set of the movement or perpendicular to the axis A1 of pivoting of the oscillator 100.

Preferably:
the first movement-blank 5 is a balance bridge 5, and/or
the second movement-blank 6 is a plate 6.

The assembly device 200 may further include a third movement-blank 8. The third movement-blank is for example a protection bridge 8. This protection bridge may in particular surround at least partly the balance 9 in order to protect the oscillator 100 and to enhance its aerodynamics. The third movement-blank 8 may be inserted or placed between the first and second movement-blanks. To be more specific, the third movement-blank 8 may be inserted or placed between the spiral spring 1 and the second movement-blank 6. Alternatively, the third movement-blank 8 may be inserted or placed between the spiral spring 1 and the first movement-blank 5. The third movement-blank is preferably clamped between the first and second movement-blanks to retain the third movement-blank.

In the embodiment represented an outer and/or solid and/or rigid part 12 of the spiral spring 1 is positioned in the plane P relative to the balance bridge 5 and/or to the plate 6 of the movement 300 by means of the first positioning element 7a, 7b. This outer and/or solid and/or rigid part 12 of the spiral spring 1 therefore serves as a connecting member of the spiral spring 1. The first positioning element is also designed to enable positioning of the balance bridge 5 relative to the plate 6 in the plane P.

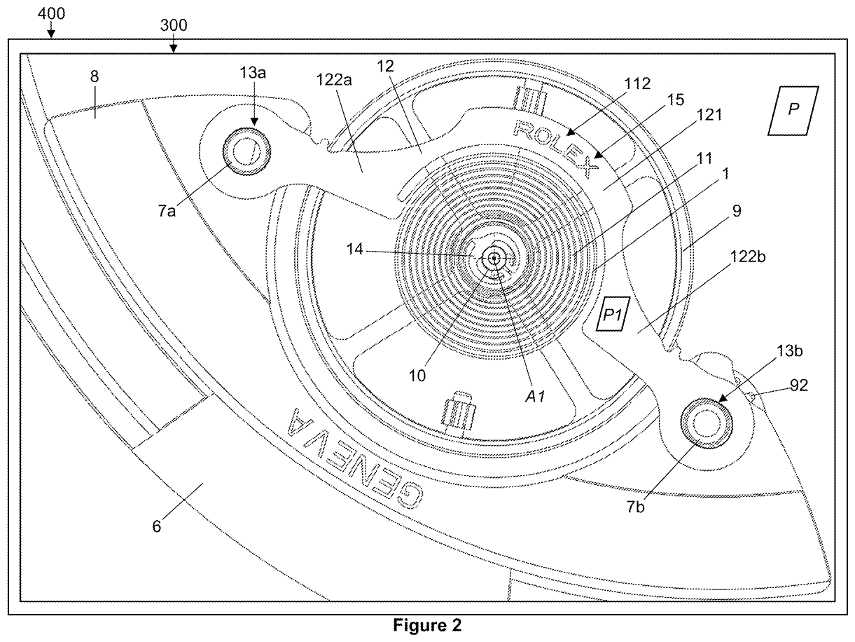

In this embodiment, the spiral spring, seen more particularly in FIG. 2, includes a blade 11 the outer end of which is fastened to the connecting member 12 the rigidity of which is significantly greater than that of the blade 11. The elements 11 and 12 lie in a plane P1 that is parallel or substantially parallel to the plane P in which the movement lies.

This connecting member 12 includes an element 13a, 13b for positioning said spiral spring 1 relative to the balance bridge 5 and to the plate 6. This positioning element 13a, 13b is designed to cooperate with the first positioning element 7a, 7b to position the spiral spring 1 relative to the balance bridge 5 and/or relative to the plate 6.

In the embodiment described, the positioning element 13a, 13b includes an opening 13a and an opening 13b. The opening 13a is for example a through-opening that takes the form of a circular section opening. The opening 13b is for example a through-opening having an oblong section.

In the embodiment described the first positioning element 7a, 7b includes a first component as a first screw foot 7a and a second component as a second screw foot 7b.

The spiral spring 1 further includes a collet 14 at the level of the inner end of the blade 11 so as to enable assembly of the spiral spring 1 onto the staff 10 in order to constitute the oscillator 100.

This oscillator 100, in particular the staff 10, pivots in bearings 50 and 60 respectively mounted on the balance bridge 5 and on the plate 6.

In the embodiment described the connecting member 12 includes a central portion 121 in the form of a ring portion, the angular extent of which is of the order of 100°, facing the axis A1. More generally, the central portion in the form of a ring portion could have an angular extent between approximately 40° and 180° inclusive. This central portion is preferably limited radially by two coaxial circle portions centred on the axis A1.

The member 12 also includes two cranked portions 122a, 122b disposed on respective opposite sides of the central portion 121 that respectively include the opening 13a and 13b each of which is designed to cooperate with the respective screw foot 7a, 7b in such a manner to position the member 12 relative to the balance bridge 5 and/or relative to the plate 6. The cranked portions connect the central portion mechanically to one and/or the other of the movement-blanks.

The member 12 preferably takes the form of a solid and/or rigid plate. The thickness of the plate (measured parallel to the axis A1) is preferably identical or similar to the thickness of the blade 11. The width of the central portion (measured radially relative to the axis A1) is 3 to 30 times or 5 to 20 times greater than the width of the blade 11. The member 12 is therefore extremely rigid in the plane P1 compared to the blade 11.

The spiral spring 1 is preferably in one piece. In other words, the blade 11, the connecting member 12 and the collet 14 are preferably made in one piece.

The first positioning element 7a, 7b is preferably included in the second movement-blank 6 and the first movement-blank 5 preferably includes a second positioning element 51a, 51b intended to cooperate with the first positioning element 7a, 7b.

In the embodiment described the first positioning element 7a, 7b includes a screw foot 7a driven into an opening 61a in the plate 6 at the level of a driving portion 74a and a screw foot 7b driven into an opening 61b in the plate 6 at the level of a driving portion 74b. In the embodiment described the openings 61a and 61b are through-openings. However, these openings could alternatively be blind openings.

The screw feet 7a, 7b are designed to come to be housed in the respective openings 13a, 13b when mounting the oscillator 100 in the movement 300.

Each screw foot 7a, 7b more particularly includes a guide portion 71a, 71b that is designed to position the spiral spring 1, in particular the connecting member 12 of the spiral spring, precisely relative to the balance bridge 5 and/or the plate 6.

The dimensions of the guide portions 71a, 71b advantageously correspond to the dimensions of the openings 13a, 13b, to within the assembly tolerance. The guide portions 71a, 71b are preferably cylindrical or at least partly cylindrical. In the embodiment described the fact that the opening 13a is circular whereas the opening 13b is oblong advantageously makes it possible to avoid any risk of hyperstaticity during assembly of the oscillator 100.

In the embodiment described the second positioning element 51a, 51b includes a through-opening 51a, in particular a through-opening having a circular section, and a through-opening 51b, in particular a through-opening having an oblong section.

These through-openings 51a, 51b are designed to receive the screw feet 7a, 7b. Each screw foot 7a, 7b more particularly includes a guide portion 72a, 72b that is designed to position the balance bridge 5 precisely in the plane P by means of the respective openings 51a, 51b.

The dimensions of the guide portions 72a, 72b advantageously correspond to the dimensions of the openings 51a, 51b, to within the assembly tolerance. The guide portions 72a, 72b are preferably cylindrical or at least partly cylindrical. In the embodiment described the fact that the opening 51a is circular whereas the opening 51b is oblong advantageously makes it possible to avoid any risk of hyperstaticity during assembly of the first movement-blank.

The third movement-blank 8 preferably includes a positioning element 81a, 81b intended to cooperate with the first positioning element 7a, 7b.

In the embodiment described the positioning element 81a, 81b includes a through-opening 81a, in particular a through-opening with a circular section, and a through-opening 81b, in particular a through-opening with an oblong section.

These through-openings 81a, 81b are designed to receive the screw feet 7a, 7b. Each screw foot 7a, 7b more particularly includes a guide portion 73a, 73b that is designed to position the third movement-blank precisely in the plane P by means of the respective openings 81a, 81b.

The dimensions of the guide portions 73a, 73b advantageously correspond to the dimensions of the openings 81a, 81b, to within the assembly tolerance. The guide portions 73a, 73b are preferably cylindrical or at least partly cylindrical. In the embodiment described the fact that the opening 81a is circular whereas the opening 81b is oblong advantageously makes it possible to avoid any risk of hyperstaticity during assembly of the third movement-blank.

Each screw foot 7a, 7b advantageously combines various functions and therefore includes:
a first guide portion 71a, 71b for the spiral spring 1;
a second guide portion 72a, 72b for the first movement-blank 5;
a third guide portion 73a, 73b for the third movement-blank 8;
a driving portion 74a, 74b in the second movement-blank 6; and
a threaded hole 75a, 75b designed to receive a first fastening element 91a, 91b.

The screw feet may alternatively be driven into the first movement-blank and/or fixed otherwise than by driving them in.

More generally, the first positioning element 7a, 7b therefore includes a first means 71a, 71b for positioning the spiral spring 1 and/or a second means 72a, 72b for positioning the first movement-blank 5 and/or a third means 73a, 73b for positioning the third movement-blank 8 and/or a fourth means 74a, 74b for positioning the second movement-blank 6.

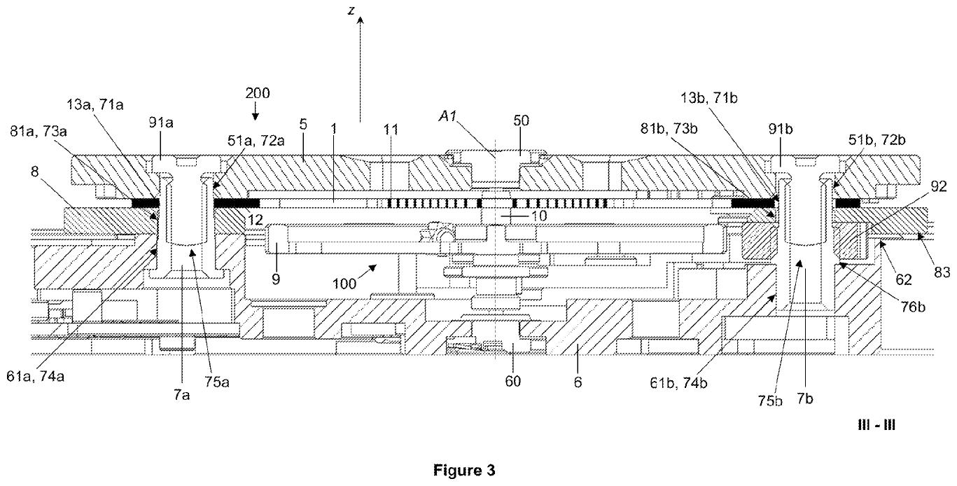

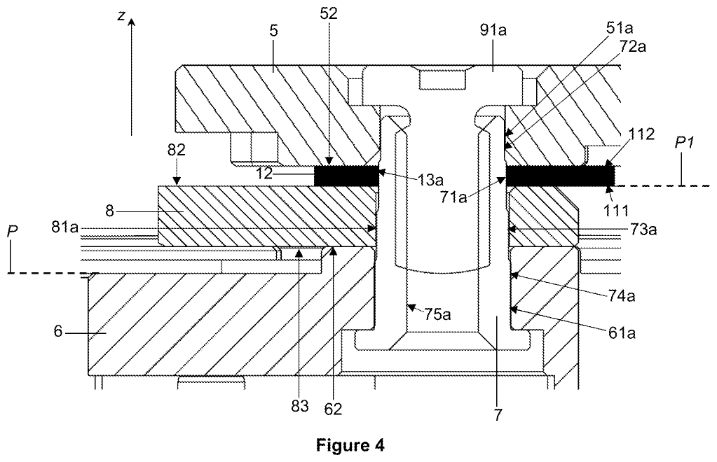

The guide portions are preferably cylindrical or at least partly cylindrical. The diameter of the guide portions 72a, 72b is advantageously less than that of the guide portions 71a, 71b. The diameter of the first guide portions 71a, 71b is advantageously less than that of the guide portions 73a, 73b. Again, the diameter of the driving portions 74a, 74b is advantageously greater than that of the guide portions. For example, the screw foot 7a may be driven into the second movement-blank 6 in the direction z represented in FIGS. 3 and 4. For example, the screw foot 7b may be driven into the second movement-blank 6 in a direction opposite the direction z.

The assembly device 200 also includes means for fastening the spiral spring 1. It more particularly includes the first fastening element 91a, 91b and a second fastening element 7a, 7b, the first fastening element 91a, 91b cooperating with the second fastening element 7a, 7b to fix the spiral spring 1 onto the first movement-blank 5 and/or onto the second movement-blank 6. The second fastening element 7a, 7b and the first positioning element 7a, 7b may therefore be combined or produced on common elements.

The first fastening element 91a, 91b may include at least one first thread and the second fastening element 7a, 7b may include at least one second thread or threaded hole 75a, 75b. Fastening is assured by screwing the first thread into the second thread, pressing the spiral spring 1 onto the first movement-blank 5 and/or onto the second movement-blank 6 and/or onto the third movement-blank 8.

In the embodiment described, the screw feet 7a, 7b serve as first positioning element and second fastening element. The first fastening element 91a, 91b includes a screw 91a and a screw 91b.

Fastening the oscillator 100 onto the rest of the assembly 300, in particular fastening the spiral spring 1, is thus effected during the fastening of the balance bridge 5 onto the plate 6 by means of screws 91a, 91b designed to be screwed into respective threaded holes 75a, 75b in the screw feet 7a, 7b.

The first movement-blank 5 and the second movement-blank 6 are advantageously arranged and/or configured to hold the spiral spring 1 clamped against them, in particular to retain the spiral spring 1 and a third movement-blank 8 that are clamped together.

To this end, a lower surface 111 of the spiral spring 1 (seen more particularly in FIG. 4) is able to come into contact with or to bear against an upper bearing surface 82 of the balance protection bridge 8 the geometry of which in the plane P at least partly circumscribes the outer perimeter of the balance 9 (see FIGS. 1 and 2). The bridge 8 is itself in contact with or pressed against the plate 6. To be more specific, a lower surface 83 of the bridge 8 is in contact with or pressed against an upper surface 62 of the plate.

Here the upper surface 112 of the connecting member 12 of the spiral spring 1 may be in contact with or pressed against a lower bearing surface 52 of the balance bridge 5. The position of the spiral spring is therefore delimited in a vertical direction z perpendicular to the plane P in a first upper side oriented sense by the balance bridge 5 and in a second lower side oriented sense by the balance protection bridge 8. Alternatively, the position of the spiral spring may be delimited in a vertical direction z perpendicular to the plane P in a first upper side oriented sense by the protection bridge 8 and in a second lower side oriented sense by the plate 6. A further alternative, in the absence of a protection bridge, is for the position of the spiral spring to be delimited in a vertical direction z perpendicular to the plane P in a first upper side oriented sense by the balance bridge 5 and in a second lower side oriented sense by the plate 6.

The assembly device 200 preferably includes a first axial clearance adjustment element 92 and a second axial clearance adjustment element 7b. The first axial clearance adjustment element 92 cooperates with the second axial clearance adjustment element 7b to adjust the axial clearance of the oscillator 100. For example, the first axial clearance adjustment element 92 includes a nut 92 and the second axial clearance adjustment element 7b includes a thread 76b. In the embodiment described the second axial clearance adjustment element 7b is the screw foot 7b. The screw foot 7b therefore includes a thread 76b.

Thanks to the solution described the spiral spring 1 is therefore positioned relative to the plate in the plane P in which the movement 300 lies by the screw feet 7a, 7b, which also make it possible to position the balance bridge 5 relative to the plate 6 in this same plane. The spiral spring 1 is moreover fixed to the movement 300 by the fastening means, in particular the screws 91a, 91b, which also enables the balance bridge 5 to be fixed to the plate 6.

A solution of this kind enables integration of a balance-spiral spring assembly 100 in a movement 300 or in an assembly or assembled module which can thereafter be mounted on the movement. This integration is independent of any spiral spring fastening mobile support movable in rotation relative to the balance bridge or to the plate in the plane of the movement.

A particular advantage of this is to highlight the central portion 121 of the connecting member 12 of the spiral spring, the upper surface 112 of which may include patterns or indications 15. Such patterns or indications 15 can therefore be visible or readable once the balance-spiral spring assembly 100 has been assembled into the movement 300. These indications or patterns may further be visible in the timepiece if using a transparent bottom.

To assure such visibility the connecting member 12 (or outer and/or solid and/or rigid part of the spiral spring) may include an upper surface 112 including an area visible in a direction parallel to the axis A1 of the oscillator 100:
greater than 3 mm² or greater than 4 mm², or
greater than 6% or than 8% of the area of a disk limited by the outside diameter of the balance 9 and centred on the balance 9.

By “visible area” we mean an area that can be seen by a user in a direction perpendicular to the plane P or a direction parallel to the axis of the oscillator when the movement is completely assembled or the timepiece is completely assembled. In particular, this visible area is not covered in this direction by any element of the movement, in particular a movement-blank or an automatic winding module. Nevertheless, in this direction a rewind oscillating weight may at least partly mask this visible area in some configurations of the oscillating weight provided that, in at least one other configuration of the oscillating weight (during operation and/or movement of the movement), the oscillating weight does not mask this visible area in this direction.

Such patterns or such indications can therefore cohabit in a harmonious and coherent manner with patterns or indications formed on other components of the movement, in particular the movement-blanks of the movement.

These patterns or indications 15 may take the form of a coating applied to the surface 112. Alternatively, these patterns or indications 15 may be the result of cavities formed in the surface 112. These cavities may be through-cavities. Alternatively, these cavities may be blind cavities. In this case, a decorative material may be deposited in the cavities. This may be, for example, a deposit of a metal layer, of paint, of lacquer, of varnish or of a composite material, in particular a luminescent composite material.

In the embodiment described only the screw foot 7b includes a nut 92 at the level of a threaded portion 76b. The position of this nut 92 in the vertical direction z relative to the screw foot 7b makes it possible to adjust the positions of the spiral spring 1, of the balance bridge 5 and of the balance protection bridge 8 in this same direction. The vertical position of the bearing 50 can therefore be adjusted relative to the vertical position of the bearing 60, which makes it possible to vary the tolerance or the clearance of the balance-spiral spring assembly 100, in particular of the staff 10 on which the spiral spring 1 is mounted. The oblong shape of the opening 13b in particular enables such movement of the spiral spring 1. Moreover, the movement of the nut 92 in the vertical direction z may lead to a loss of contact between the bridge 8 and the plate 6, in particular between the surface 83 of the bridge 8 and the surface 62 of the plate 6, in a zone surrounding the screw foot 7b, as represented in FIG. 3. In this situation the bridge 8 bears against the nut 92.

Alternatively, the two screw feet 7a, 7b may include nuts at the level of threaded portions in order to adjust the clearance of the oscillator.

In a simplified embodiment the first positioning element 7a, 7b may be devoid of any means for adjustment of the axial clearance of the oscillator 100. In this context, a means for adjustment of the axial clearance of the oscillator 100 may eventually be provided in an ancillary device, for example disposed at the level of the bearing 50 and/or of the bearing 60.

In the embodiment described above the first positioning element 7a, 7b forms part of the second movement-blank 6 and the first movement-blank 5 includes a second positioning element 51a, 51b intended to cooperate with the first positioning element 7a, 7b. However, in addition to this or instead of this, a first positioning element may be included in the first movement-blank and the second movement-blank may include a second positioning element intended to cooperate with the first positioning element.

In an alternative embodiment the first positioning element 7a, 7b may include two pins. These pins enable positioning, in the plane P, of the balance bridge relative to the plate and the balance-spiral spring, in particular of the spiral spring, in the plane P relative to the balance bridge and/or to the plate. In this instance, the openings 51a, 51b are not necessarily through-openings. The balance bridge may be fixed by first fastening means such as screws directly to the plate and the spiral spring may be fixed to the movement by second fastening means such as screws, which may be different from the first fastening means.

In a simplified embodiment the first positioning element 7a, 7b may take the simpler form of a single component such as a screw foot 7a or a screw foot 7b, or a pin.

In an alternative embodiment the first positioning element 13a, 13b of the spiral spring may include two opening portions that define guide surfaces designed at least partially to espouse the guide portions 71a, 71b. In a simplified embodiment the first positioning element 7a, 7b may take the simpler form of a single opening or opening portion.

In the embodiment described above the first movement-blank takes the form of a through-balance-bridge. Of course, the balance bridge may equally take the form of a balance cock.

In the embodiment described above the first movement-blank takes the form of a balance bridge and the second movement-blank takes the form of a plate. These movement-blanks are fixed relative to the frame of the movement. Alternatively, the first and second movement-blanks may be integrated into a module, in particular a tourbillon module or a karussel module mounted on a frame of the movement.

In the embodiment described above the spiral spring 1 is in one piece. In other words, the blade 11, the connecting member 12 and the collet 14 are made in one piece. Alternatively, the spiral spring could take the form of an assembly, the connecting member 12 being for example mountable on the blade 11 as described in the application JP2016173241.

In the embodiment described above the spiral spring 1 includes only one blade 11. Alternatively, the spiral spring may include a plurality of blades, in particular two blades.

The spiral spring may include in whole or in part:
monocrystalline silicon whatever its orientation,
polycrystalline silicon,
amorphous silicon,
amorphous silicon dioxide,
doped silicon whatever the type and level of doping, or again
porous silicon.

It may also include in whole or in part:
silicon carbide,
glass,
ceramic, or
quartz.

Alternatively, the spiral spring may be made of metal or a metal alloy, in particular a paramagnetic alloy, such as an alloy based on Nb—Zr for example.

In a simplified embodiment it is possible to mount the spiral spring directly on the plate independently of any balance protection bridge. In this particular case the lower surface 111 of the spiral spring 1 may bear against an upper bearing surface 62 of the plate 6.

The quality and control improvements of the methods of manufacturing and assembling components forming part of the oscillator combined with the use of an assembly solution in accordance with the invention enable reliable and repeatable positioning of the centre of the balance plate pin independently of any ancillary adjustment means such as a mobile spiral spring fastening support, such as a balance-spring stud carrier for example.

It is therefore possible significantly to simplify the assembly devices of a balance-spiral spring oscillator to fix the outer end of a spiral spring to movement-blanks that pivot the oscillator, in particular the plate and the balance bridge.

A solution of this kind is particularly advantageous given its simplicity of use and the few components that it requires. In particular it makes it possible to dispense with the mobile fastening support, in particular balance-spring stud carrier, balance-spring stud or clamp enabling the fastening of a spiral spring to such a mobile support. It also makes it possible to dispense with any friction element enabling the mobile fastening support to be retained in a given angular position. This kind of solution is therefore not subject to the variations of the angular positions of a mobile fastening support, in particular after a shock. This kind of solution also makes it possible to minimise the overall size, in particular the overall size along the axis A1, of a balance-spiral spring oscillator, and moreover enables integration of a spiral spring with decorative patterns able to cohabit in a harmonious and coherent manner with other decorative patterns of the movement.

The spiral spring assembly solution described hereinabove also makes it possible to optimise the precision of assembly of a balance-spiral spring oscillator in a movement.

Thanks to the invention, it is therefore possible to propose an assembly device of a balance-spiral spring oscillator in which the outer end of the spiral spring is positioned relative to first and second movement-blanks of the balance-spiral spring oscillator, for example a plate and a balance bridge, by means of positioning means also designed to enable the positioning of the first movement-blank relative to the second movement-blank, for example the positioning of the balance bridge relative to the plate of the movement.

The spiral spring is therefore positioned relative to the plate with the same means as those that enable the positioning of the balance bridge relative to that same plate. The chain of dimensions is therefore minimised as much as it can be, while benefiting from the already known elements of the movement. The absence of any spiral spring mobile fastening support moreover enables thinning of the thickness of the movement at the level of the regulating member, while allowing easy demounting and refitting of the balance-spiral spring. The absence of any such support also makes it possible to render visible and to valorise the outer end of the spiral spring, in particular a connecting member in accordance with a specific shaping of the spiral spring such as that described in the document EP2437126B1.

In accordance with a second aspect of the invention, an assembly is defined as follows:

Assembly 300, in particular a timepiece movement, including:
an oscillator 100 including a balance 9 and a spiral spring 1,
a first movement-blank 5 for pivoting the oscillator 100, and
a second movement-blank 6 for pivoting the oscillator 100, the spiral spring 1 including an outer and/or solid and/or rigid part 12 of the spiral spring having an upper surface 112 having an area visible in a direction parallel to an axis A1 of a balance 9 of the oscillator 100:
greater than 3 mm² or greater than 4 mm², or
greater than 6% or than 8% of the area of a disk limited by the outside diameter of the balance 9 and centred on the balance 9.

In accordance with a third aspect of the invention, an assembly is defined as follows:

Assembly 300, in particular timepiece movement, including:
an oscillator 100 including a balance 9 and a spiral spring 1, and
a plate 6 of the balance 9 including a first positioning and/or fastening element 7a, 7b, the spiral spring 1, in particular an outer and/or solid and/or rigid part 12 of the spiral spring, including a second positioning element 13a, 13b intended to cooperate with the first positioning and/or fastening element 7a, 7b to position and/or to fasten the spiral spring 1 directly to the plate 6.

In this third aspect, the assembly preferably includes a second fastening element, such as a screw, intended to cooperate with the first fastening element to fasten the spiral spring 1 directly to the plate 6.

By “direct positioning and/or fastening of the spiral spring to the plate” is meant that the spiral spring is positioned and/or fastened to the plate without interposition of any other element and/or without the participation of another movement-blank of the movement (such as in particular a protection bridge or a balance bridge or an escapement lever bridge).

Preferably, whatever the embodiment, as mentioned above, the solution provides an assembly device of the oscillator improving the integration of the oscillator within the movement, more particularly a spring spiral of the oscillator within the movement, and this independently of any movable fixing support movable in rotation relative to a balance bridge or a plate in the plane of the movement. Thus, preferably, the device for assembling does not comprise a support movable in rotation relating to a movement-blank in the plane P of the assembly 300 or of the movement, the support being used for fixing the spiral spring.

Preferably, whatever the embodiment, the assembly does not comprise a spiral spring that is adjustable or movable, notably in rotation, in particular in rotation around the axis A1, relative to a movement-blank in a plane of the movement. Thus, the position of the spiral spring is not adjustable in the plane of the movement. This position is defined by the first positioning element 7a, 7b. This means that the first positioning element 7a, 7b positions the spiral spring 1, in the plane P, relative to the first movement-blank 5 and/or relative to the second movement-blank 6, without any degree of freedom. However a slight assembling clearance may be provided between:
the spiral spring 1, and
the first movement-blank 5 and/or the second movement-blank 6.

For example, this assembling clearance may being less than 0.05 mm in translation in the plane P and/or less than 1° in rotation in the plane P.

Unless there is some logical or technical incompatibility, all features of the first, second and third aspects can be combined.

1. A device for assembling an oscillator including a spiral spring to an assembly or to a movement of a timepiece, the assembly device including:
a first movement-blank for pivoting the oscillator,
a second movement-blank,
a first element for positioning the first movement-blank relative to the second movement-blank, the first positioning element being arranged and/or configured so as to position a spiral spring relative to the first movement-blank and/or relative to the second movement-blank in a plane of the assembly or of the movement.

2. The assembly device as claimed in claim 1, wherein:
the first positioning element is included in the second movement-blank and the first movement-blank includes a second positioning element intended to cooperate with the first positioning element, or
the first positioning element is included in the first movement-blank and the second movement-blank includes a second positioning element intended to cooperate with the first positioning element.

3. The assembly device as claimed in claim 2, wherein the second positioning element includes a first opening and/or a second opening.

4. The assembly device as claimed in claim 1, wherein:
the first movement-blank is a balance bridge, and/or
the second movement-blank is a plate.

5. The assembly device as claimed in claim 1, wherein the assembly device includes a third movement-blank.

6. The assembly device as claimed in claim 1, wherein the assembly device includes a first fastening element and a second fastening element, first fastening element cooperating with the second fastening element to fasten a spiral spring to the first movement-blank and/or to the second movement-blank.

7. The assembly device as claimed in claim 6, wherein the second fastening element and the first positioning element are merged.

8. The assembly device as claimed in claim 6, wherein the first fastening element includes at least one first thread and in that the second fastening element includes at least one second thread, fastening being achieved by screwing the first thread into the second thread to press the spiral spring onto the first movement-blank and/or onto the second movement-blank.

9. The assembly device as claimed in claim 1, wherein the first positioning element includes a first means for positioning the spiral spring and/or a second means for positioning the first movement-blank and/or a third means for positioning the third movement-blank and/or a fourth means for positioning the second movement-blank.

10. The assembly device as claimed in claim 1, wherein the first positioning element includes a first screw foot and/or a second screw foot.

11. The assembly device as claimed in claim 1, wherein the assembly device includes a first axial clearance adjustment element and a second axial clearance adjustment element, the first axial clearance adjustment element cooperating with the second axial clearance adjustment element to adjust the axial clearance of an oscillator.

12. The assembly device as claimed in claim 1, wherein the first movement-blank and the second movement-blank are arranged and/or configured to retain a spiral spring between them.

13. An assembly including an assembly device as claimed in claim 1 and an oscillator including a spiral spring.

14. The assembly as claimed in claim 13, wherein the spiral spring includes a third positioning element aped to cooperate with the first positioning element.

15. The assembly as claimed in claim 14, wherein the third positioning element includes a third opening.

16. A timepiece including an assembly as claimed in claim 13.

17. The assembly as claimed in claim 13, wherein the oscillator includes a balance and the spiral spring mounted on a staff.

18. The assembly as claimed in claim 14, wherein an outer and/or solid and/or rigid part of the spiral spring includes the third positioning element.

19. The assembly device as claimed in claim 3, wherein the second positioning element includes a first opening having a circular section and a second opening having an oblong section.

20. The assembly device as claimed in claim 5, wherein the third movement-blank is a protection bridge inserted or disposed between the first and second movement-blanks.
